(19) United States
(12) Patent Application Publication
(10) Pub. No.: US 2025/0365027 A1
(43) Pub. Date: Nov. 27, 2025

(54) SIGNAL DESIGN FOR BACKSCATTER COMMUNICATION

(71) Applicant: Sony Group Corporation, Tokyo (JP)

(72) Inventors: Nafiseh Seyed MAZLOUM, Lund (SE); Ove EDFORS, Södra Sandby (SE)

(21) Appl. No.: 18/875,137

(22) PCT Filed: Jun. 1, 2023
(86) PCT No.: PCT/EP2023/064723

§ 371 Date: Dec. 14, 2024

(30) Foreign Application Priority Data
Jun. 29, 2022 (SE) 2250803-0

(51) Int. Cl. H04B 1/10; H04B 1/707

(52) U.S. Cl. CPC H04B 1/10; H04B 1/707

(57) ABSTRACT

Examples disclose a method of transmitting a data bit by passing or absorbing, by a wireless device, an incoming signal, the method comprising: for a data bit value zero, obtaining a first pattern comprising a number of chips having a predefined duration; for a data bit value one, obtaining a second pattern comprising the number of chips having the predefined duration; and either passing or absorbing, during each chip, the incoming signal in accordance with the first pattern or the second pattern, wherein the first pattern and the second pattern are selected to have an equal number of chips during which the incoming signal is absorbed. Further, examples disclose a method of receiving a data bit.

### TECHNICAL FIELD

Various examples generally relate to transmitting data using backscattering communication.

### BACKGROUND

Modern data transmission relies to a large extend on wireless communication. Conventional radio communication requires transmitting devices to generate radio signals using components such as digital-to-analog converters (DACs), mixers, oscillators and power amplifiers and receiving devices using components low noise amplifiers, mixers, oscillators, and analog-to-digital converters (ADCs) to receive the radio signals. Usually, devices participating in wireless communication are battery powered and the aforementioned components for wireless communication consume a substantial amount of the energy provided by the battery. Hence, the batteries will have to be recharged or replaced regularly. With an increasing amount of battery powered devices participation in wireless communication, this may not be feasible anymore. For example, a number of one trillion Internet-of-things (IoT) devices worldwide each having a 10-year battery lifetime would already imply that 274 billion batteries would have to be changed every single day. However, in several use cases a 10-year battery lifetime may not even be achievable with known technologies.

Moreover, battery recycling is still insufficient. In 2018, 191 000 tons of portable batteries were sold in the European Union but only less than half of said quantity, i.e. 88 000 tons of used portable batteries, is collected as waste to be recycled. The demand for new batteries has to be reduced too in view of the limited natural resources required for battery production.

### SUMMARY

Accordingly, there may be a need for data transmission involving less power consumption. Said need has been addressed with the subject-matter of the independent claims. Advantageous embodiments are described in the dependent claims.

Examples disclose a method of transmitting a data bit by passing or absorbing, by a wireless device, an incoming signal, the method comprising: for a data bit value zero, obtaining a first pattern comprising a number of chips having a predefined duration; for a data bit value one, obtaining a second pattern comprising the number of chips having the predefined duration; and either passing or absorbing, during each chip, the incoming signal in accordance with the first pattern or the second pattern, wherein the first pattern and the second pattern are selected to have an equal number of chips during which the incoming signal is absorbed.

Further, examples disclose a method of receiving a data bit transmitted by a wireless device by passing or absorbing an incoming signal, by a communication node, the method comprising: obtaining a third pattern comprising a number of chips having a predefined duration, wherein a chip of the third pattern is zero if corresponding chips of a first pattern associated with a data bit value zero and a second pattern associated with a data bit value one are equal, wherein a chip of the third pattern has a positive sign if a corresponding chip of the first pattern is greater than a corresponding chip of the second pattern, wherein a chip of the third pattern has a negative sign if a corresponding chip of the first pattern is smaller than a corresponding chip of the second pattern; and decoding a received pattern representing the data bit based on the third pattern.

Additionally, examples disclose a wireless device comprising circuitry configured for performing the aforementioned method of transmitting a data bit and a communication node comprising circuitry configure for performing the aforementioned method of receiving a data bit.

### BRIEF DESCRIPTION OF THE DRAWINGS

FIG. 1 schematically illustrates backscattering communication;

FIG. 2 schematically illustrates transmission circuitry for backscattering communication;

FIG. 3 schematically illustrates transmission patterns;

FIG. 4 schematically illustrates a modulated channel;

FIG. 5 schematically illustrates receiving circuitry for backscattering communication;

FIG. 6 schematically illustrates synchronization circuitry for backscattering communication;

FIG. 7 schematically illustrates receiving circuitry for multiple-device backscattering communication;

FIG. 8 schematically illustrates relations between a signal to interference ratio and a spreading factor;

FIG. 9 schematically illustrates transmitting a data bit; and

FIG. 10 schematically illustrates receiving a data bit.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

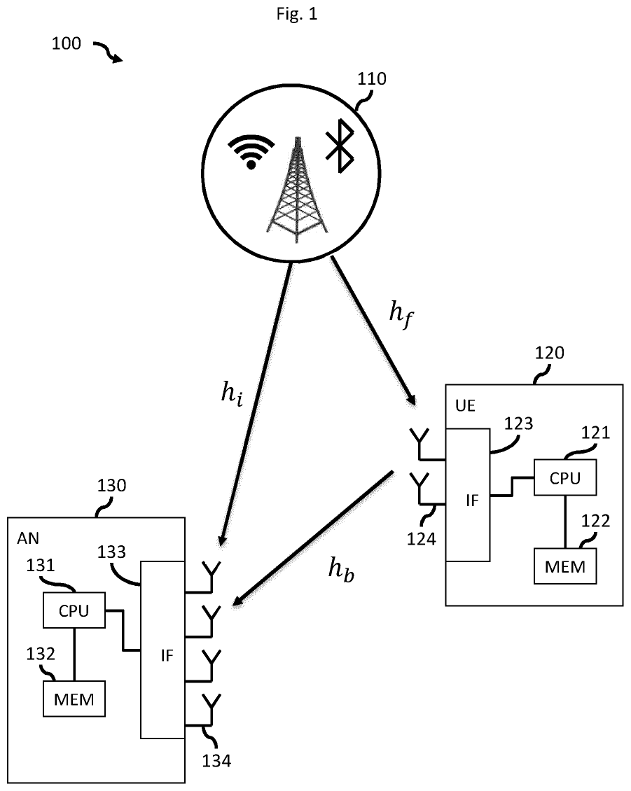

FIG. 1 illustrates a typical modern communication environment 100 comprising a wireless device 120 and a receiver device 130. The wireless device 120 includes circuitry that is implemented by a processor 121, a non-volatile memory 122 and an interface 123 that can access and control one or more antennas 124. Likewise, the receiver device 130 comprises circuitry that is implemented by a processor 131, a non-volatile memory 132 and an interface 133 that can access and control one or more antennas 134. As explained before, modern data transmission relies to a large extend on wireless communication. Hence, many RF sources 110 may be present in a typical environment. RF sources may comprise TV towers, cellular base stations, Bluetooth transmitters and Wi-Fi access points.

Instead of generating and transmitting radio waves using power hungry components, modulating and/or reflecting already existing ambient RF signals may allow for substantial power savings. Such an approach is also known as backscattering communication (BSC).

As shown in FIG. 1, the receiver device 130 may receive the ambient RF signals via an interference channel hᵢ. In addition, the receiver device 130 may receive the ambient RF signals via a further channel h_{f}h_{b} provided by a wireless device 120. The wireless device 120 may influence said channel h_{f}h_{b} by backscatter modulation, i.e. by controlling h_{b}. In particular, the wireless device 120 may reflect or absorb an incoming ambient signal received via the channel h_{f}.

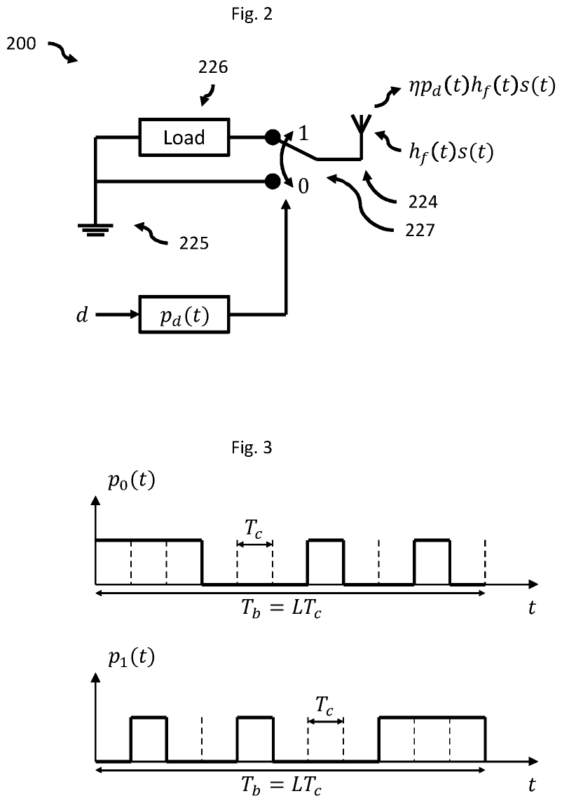

FIG. 2 illustrates possible circuitry 200 of the wireless device 120. The wireless device 120 receives the signal s(t) arriving at the wireless device 120 via the channel h_{f} with antenna 224. In response to a data bit d, the wireless device 120 reflects or absorbs the incoming signal h_f(t)s(t) depending on whether a pattern p_{d} prescribes connecting the antenna 224 to ground 225 (i.e., p_{d}(t)=0) or to the load 226 (i.e., p_{d}(t)=1). Thus, the wireless device 120 may pass the signal η p_{d}(t)h_{f}(t)s(t), wherein the term η is indicative of the reflection efficiency. The pattern p_{d}(t) may be selected based on the data bit value of the data bit d.

The circuitry of the wireless device 120 used for modulating the load applied to the antenna 224 shown in FIG. 2 consists only of a switch 227 and a load (i.e., impedance) 226. Thus, the circuitry may be of low complexity and very energy efficient.

FIG. 3 illustrates a first pattern p₀(t) associated with a data bit value zero and a second pattern p₁(t) associated with a data bit value one. Both patterns comprise a number of L chips. The term “chip” may denote a certain time interval. The chips have a predetermined duration T_{c}. Accordingly, the total duration of the patterns, which may also be called bit time, is T_{b}=L T_{c}. The first transmission pattern p₀(t) and the second transmission pattern p₁(t) are selected to have an equal number of chips with level zero. This implies that the number of chips with level one is also the same for both the first transmission pattern p₀(t) and the second transmission pattern p₁(t). The first pattern p₀(t) and/or second pattern p₁(t) may be structured as On-Off-Keying (OOK) sequences with levels one and zero.

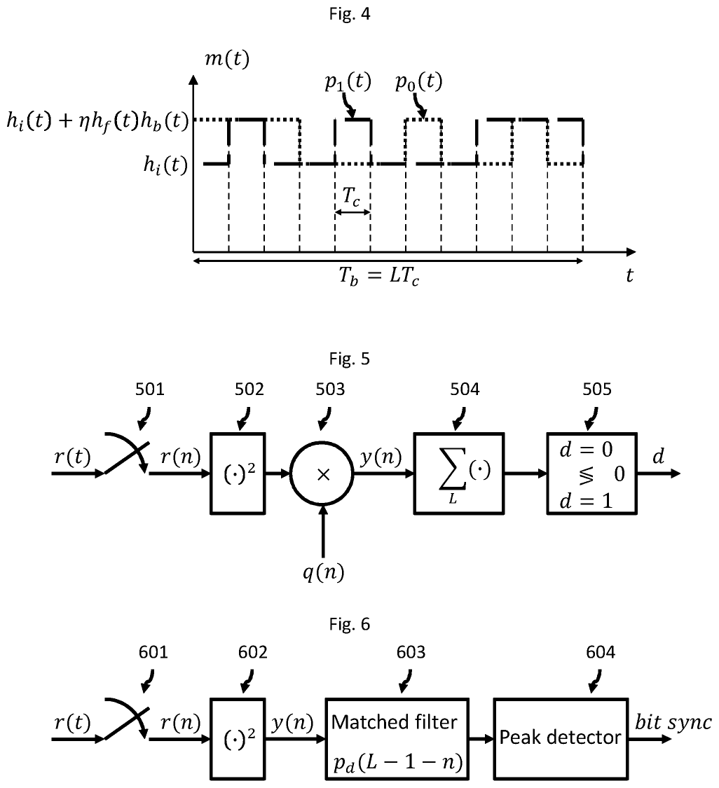

FIG. 4 illustrates a modulation factor m(t) experienced by a receiver device 130 under the assumption that variations of the non-modulated channel hᵢ(t) are negligible during the bit time T_{b}=L T_{c}. The modulation factor m(t) are shown for a situation when the wireless device 103 applies the first pattern p₀(t) and for a situation when the wireless device 103 applies the second pattern p₁(t).

The modulation factor m(t) may be expressed as

$$m ( t ) = {h}_{i} ( t ) + η \cdot {h}_{f} ( t ) {h}_{b} ( t ) {p}_{d} ( t )$$

wherein hᵢ represents the non-modulated interference channel, η the reflection efficiency of the wireless device 120, h_{f}(t) the channel between the ambient source 110 and the wireless device 120, h_{b}(t) the channel between the wireless device 120 and the receiver device 130, and p_{d}(t) the pattern applied by the wireless device 120.

Thus, the receiver device 130 may receive the following signal

$$r ( t ) = ( {h}_{i} ( t ) + η \cdot {h}_{f} ( t ) {h}_{b} ( t ) {p}_{d} ( t ) ) s ( t )$$

FIG. 5 illustrates a method of receiving a data bit d transmitted by the wireless device 120 by the receiver device 130. In particular, FIG. 5 illustrates decoding the received signal r(t) by the receiver device 130 (FIG. 1).

At 501, the received signal r(t) may be sampled according to the predetermined duration T_{c} to obtain a received pattern r(n) representing the data bit d. At 502, the elements of the received pattern r(n) may be transformed to obtain only positive values (e.g., the elements may be squared or an absolute value of the elements may be determined) and afterwards, at block 503, multiplied with a corresponding element of a third pattern q(n). The elements of the third pattern q(n) may be defined as follows:

$$q ( n ) = \{ \begin{matrix}1 , & {p}_{1} ( n ) = 1 ∧ {p}_{0} ( n ) = 0 \\ - 1 , & {p}_{1} ( n ) = 0 ∧ {p}_{0} ( n ) = 1 \\ 0 , & otherwise\end{matrix}$$

$$if \vert \frac{η {h}_{f} {h}_{b}}{{h}_{i}} + 1 \vert > 1$$

otherwise as the negation of the above definition.

This may result in a fourth pattern y(n). A sum over all L members of the fourth pattern y(n) may be calculated at 504:

$${\sum }_{L} y ( n )$$

The result may be compared with zero to obtain the value of the data bit at 505:

$$d = \{ \begin{matrix}0 , & {\sum }_{L} y ( n ) < 0 \\ 1 , & {\sum }_{L} y ( n ) > 0\end{matrix}$$

The data bit value may be decoded to be zero, if the sum is smaller than zero. Correspondingly, the data bit value me decoded to be one, if the sum is larger than zero.

It is in particular the choice of the same amount of chips having the level zero for the first transmission pattern p₀(t) and the second transmission pattern p₁(t) that permits the particularly simple method for decoding the received signal. In particular, it may allow for eliminating the need for an estimation of a detection threshold for a Maximum Likelihood (ML) detector at the receiver device. It may also allow for omitting pilot information for this purpose. All this may contribute to a very simple and low-power detection scheme.

The proposed transmission of a single data bit across L chips may allow for substantial processing gains at the receiver device helping to overcome a high interference level associated with backscattering communication. The processing gain may be adjusted appropriately by selecting the value of L.

In some examples, the transmission patterns p₀(t) and p₁(t) may be selected to have a peak to off-peak auto-correlation ratio of at least L/2. This may allow for synchronization using the patterns p₀(t) and p₁(t) having the same bit time T_{b}=L·T_{c}, i.e. the same number of L chips.

FIG. 6 schematically illustrates circuitry which may be used by a receiver device for bit synchronization. At 601, the received signal r(t) may be sampled according to the predetermined duration T_{c} to obtain a received pattern r(n) representing the data bit d. At 602, the elements of the received pattern r(n) may be transformed to obtain only positive values (e.g., the elements may be squared or an absolute value of the elements may be determined). At 603, matched filters p_{d}(L−1−n) may be applied to the received pattern y(n). After application of the filters, a peak may be detected (604) to obtain a bit synchronization signal bit sync.

There may be a need for multiple wireless devices being able to transmit data bits d using backscattering techniques. Using a third transmission pattern p₂(t) and a fourth transmission pattern p₃(t) having L chips for a further wireless device, wherein a peak to off-peak cross-correlation ratios with the first transmission pattern p₀(t) and the second transmission pattern p₁(t) are at least

$$\sqrt[2]{L / 2}$$

may allow for identification of the different wireless devices and multiple access.

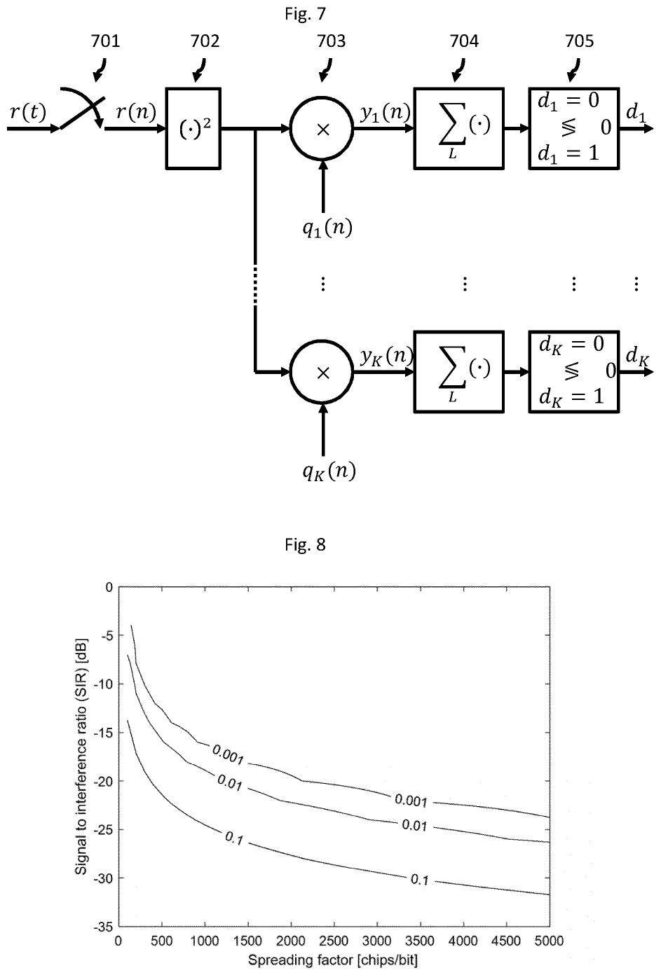

FIG. 7 illustrates a method of receiving data bits d transmitted by multiple wireless devices by a receiver device similar to the method described with respect to FIG. 5.

Summarizing, examples disclosed herein may allow for power efficient transmission of data using ambient RF signals s(t) even if the respective RF sources are unpredictable as well as uncontrollable.

At 701, the received signal r(t) may be sampled according to the predetermined duration T_{c} to obtain a received pattern r(n) representing a data bit d received from one of the wireless devices. At 702, the elements of the received pattern r(n) may be transformed to obtain only positive values (e.g., the elements may be squared or an absolute value of the elements may be determined) and afterwards, at 703, multiplied with corresponding elements of third patterns qₖ(n) with k∈1 . . . K. The elements of the third patterns qₖ(n) may be defined as follows:

$${q}_{k} ( n ) = \{ \begin{matrix}1 , & {p}_{k 1} ( n ) = 1 ∧ {p}_{k 0} ( n ) = 0 \\ - 1 , & {p}_{k 1} ( n ) = 0 ∧ {p}_{k 0} ( n ) = 1 \\ 0 , & otherwise\end{matrix}$$

$$if \vert \frac{η {h}_{f , k} {h}_{b , k}}{{h}_{i , k}} + 1 \vert > 1$$

otherwise as the negation of the above definition.

This may result in fourth patterns yₖ(n). A sum over all L members of the fourth patterns may be calculated at 704:

$${\sum }_{L} {y}_{k} ( n )$$

The result may be compared with zero to obtain the value of the data bit dₖ:

$${d}_{k} = \{ \begin{matrix}0 , & {\sum }_{L} {y}_{k} ( n ) < 0 \\ 1 , & {\sum }_{L} {y}_{k} ( n ) > 0\end{matrix}$$

The data bit value may be decoded to be zero, if the sum is smaller than zero. Correspondingly, the data bit value me decoded to be one, if the sum is larger than zero.

Similarly different receiver devices may be addressed with the same length L transmission patterns if the patterns used in different receiver devices are chosen so that their peak to off-peak cross-correlation ratios are at least

$$\sqrt[2]{L / 2} .$$

Examples may allow for the combination of different p_{d}(n) to be used for wireless device identification and receiver device addressing. For example, from the set of bit information b₀, b₁, . . . , b_{N}, one or more information bits, b₀ . . . bᵢ₋₁, may be encoded with patterns p_{d,rx}(n) which address the respective receiving device, and all the other information bits, bᵢ . . . b_{N}, may be encoded by p_{d,tx}(n) which is unique for the respective wireless device.

FIG. 8 shows the result of theoretical calculations, which have been verified by simulations, illustrating the relation between a signal to interference ratio and a required spreading factor for three different raw bit error rates (0.1, 0.01, and 0.001) assuming a non-fading environment. The spreading factor corresponds to the predefined number L of chips per transmission pattern p_{d}(t).

For instance, approximately 1300 chips per transmission pattern p_{d}(t) might be sufficient to achieve a bit error rate of 0.01 in an environment having a signal to interference ratio of −20 dB.

Backscattering communication techniques described herein may be particularly useful in comparably static environments.

Ambient signals used for BSC may have different carrier frequencies. Selecting a predefined duration T_{c} of the chips of less than 180 ms (T_{c}<180 ms) may be particularly useful when a carrier frequency of an ambient RF signal to be used for BSC is expected to be below 2.5 GHz. Selecting a predefined duration T_{c} of the chips of less than 60 ms (T_{c}<60 ms) may be particularly useful when a carrier frequency of an ambient RF signal to be used for BSC is expected to be below 7 GHz. Selecting a predefined duration T_{c} of the chips of less than 24 ms (T_{c}<24 ms) may be particularly useful when a carrier frequency of an ambient RF signal to be used for BSC is expected to be below 17 GHz. Selecting a predefined duration T_{c} of the chips of less than 13 ms (T_{c}<13 ms) may be particularly useful when a carrier frequency of an ambient RF signal to be used for BSC is expected to be below 30 GHz. Selecting a predefined duration T_{c} of the chips of less than 9 ms (T_{c}<9 ms) may be particularly useful when a carrier frequency of an ambient RF signal to be used for BSC is expected to be below 40 GHz. Selecting a predefined duration T_{c} of the chips of less than 6 ms (T_{c}<6 ms) may be particularly useful when a carrier frequency of an ambient RF signal to be used for BSC is expected to be below 65 GHz. Selecting a predefined duration T_{c} of the chips of less than 5 ms (T_{c}<5 ms) may be particularly useful when a carrier frequency of an ambient RF signal to be used for BSC is expected to be below 65 GHz.

A larger value of the predefined duration T_{c} of the chips may require less switching in the wireless resulting in a lower energy consumption of the wireless device.

Selecting a predefined duration T_{c} of more than 10 ns (T_{c}<10 ns) may useful if a very short delay spread as specified by the 3GPP is to be expected. Selecting a predefined duration T_{c} of more than 30 ns (T_{c}<30 ns) may useful if a short delay spread as specified by the 3GPP is to be expected. Selecting a predefined duration T_{c} of more than 100 ns (T_{c}<100 ns) may useful if a nominal delay spread as specified by the 3GPP is to be expected. Selecting a predefined duration T_{c} of more than 300 ns (T_{c}<300 ns) may useful if a long delay spread as specified by the 3GPP is to be expected.

Selecting a predefined duration T_{c} of more than 1000 ns (T_{c}<300 ns) may useful if a very long delay spread as specified by the 3GPP is to be expected.

Smaller values of the predefined duration T_{c} may spread the backscattered signal more over the available bandwidth leading to a more efficient use of the available spectrum.

Preferably, the predefined duration T_{c} is selected to be significantly longer than a delay spread of a channel to be used for BSC and significantly shorter than a coherence time of said channel.

For example, the predefined duration T_{c} may by selected to fulfil the equation

$$0.5 μ s ≪ {T}_{c} ≪ 200 m sec$$

Such a predefined duration T_{c} may be suitable in a scenario when the environment is represented by the standardized Extended Pedestrian A (EPA) channel model. In the EPA model the Doppler spread is 5 Hz, corresponding to coherence time of about 200 ms and a delay spread of less than 500 ns.

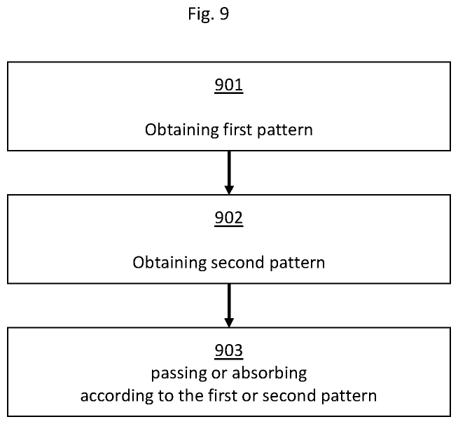

FIG. 9 illustrates a method of transmitting a data by passing, in particular reflecting or forwarding, or absorbing, by a wireless device, an incoming signal, in particular an incoming ambient signal.

At 901 the method prescribes, for a data bit value zero, obtaining a first pattern (p₀) comprising a number (L) of chips having a predefined duration (T_{c}). At 902, the method prescribes, for a data bit value one, obtaining a second pattern (p₁) comprising the number (L) of chips having the predefined duration (T_{c}). In another example, the method may prescribe obtaining the second pattern (p₁) before the first pattern (p₀).

Obtaining the first and/or second pattern may comprise obtaining the pattern from a codebook. For example, obtaining the first and/or second pattern may comprise reading the pattern from a memory of the wireless device. Obtaining the first and/or second pattern may also comprise obtaining, e.g. receiving, a message from another communication device indicating the pattern associated with the respective data bit value. The message may be broadcasted or specifically addressed to the wireless device.

At 903, the method prescribes either passing or absorbing, during each chip, the incoming signal in according with the first pattern or the second pattern. For example, if a data bit value zero is to be transmitted, the wireless device is to pass and absorb the incoming signal according to the first pattern.

The first pattern and the second pattern are selected to have an equal number of chips during which the incoming signal is absorbed.

Passing may comprise reflecting or forwarding the incoming signal. For example, reflecting may be performed using a circuit as described with reference to FIG. 2. Forwarding may refer to a situation in which incoming signals may pass through the wireless device (for example, through a transparent screen).

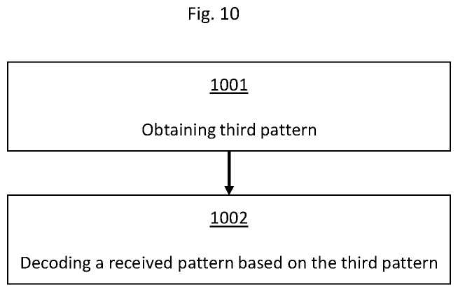

FIG. 10 illustrates a method of receiving a data bit transmitted by a wireless device by passing, in particular reflecting or forwarding, or absorbing an incoming signal, in particular an incoming ambient signal by a receiver device.

At 1001, the method prescribes obtaining a third pattern (q) comprising a number (L) of chips having a predefined duration (T_{c}).

A chip of the third pattern (q) is zero if corresponding chips of a first pattern (p₀) associated with a data bit value zero (0) and a second pattern (p₁) associated with a data bit value one (1) are equal. A chip of the third pattern (q) has a positive sign if a corresponding chip of the first pattern is greater than a corresponding chip of the second pattern (p₁). A chip of the third pattern (q) has a negative sign if a corresponding chip of the first pattern (p₀) is smaller than a corresponding chip of the second pattern (p₁).

At 1002, the method prescribes decoding a received pattern (r) representing the data bit based on the third pattern (q).

Summarizing, at least the following EXAMPLES have been described above:
EXAMPLE 1. A method of transmitting a data bit by passing, in particular reflecting or forwarding, or absorbing, by a wireless device, an incoming signal, in particular an incoming ambient signal, the method comprising:
   for a data bit value zero (0), obtaining (901), in particular from a codebook, a first pattern (p_0) comprising a number (L) of chips having a predefined duration (T_{c}),
   for a data bit value one (1), obtaining (902), in particular from the codebook, a second pattern (p₁) comprising the number (L) of chips having the predefined duration (T_{c}), and
   either passing or absorbing (903), during each chip, the incoming signal in accordance with the first pattern (p₀) or the second pattern (p₁),
wherein the first pattern (p₀) and the second pattern (p₁) are selected to have an equal number (M<L) of chips during which the incoming signal is absorbed.
EXAMPLE 2. The method of EXAMPLE 1,
wherein the first pattern (p₀) and the second pattern (p₁) are different.
EXAMPLE 3. The method of EXAMPLE 1 or 2,
wherein the number (M<L) of chips during which the incoming signal is absorbed is less than six eighths ( 6/8), in particular less than five eighths (⅝), more particularly less than four eighths ( 4/8) of the number (L) of chips of the first pattern (p₀).
EXAMPLE 4. The method of any one of EXAMPLEs 1 to 3,
wherein the number (M<L) of chips during which the incoming signal is absorbed is more than two eights ( 2/8), in particular more than three eighths (⅜), more particularly more than four eighths ( 4/8) of the number (L) of chips of the first pattern (p₀).
EXAMPLE 5. The method of any one of EXAMPLEs 1 to 4,
wherein a number (N<L) of chips where the first pattern (p₀) and the second pattern (p₁) differ is more than three eighths (⅜), in particular more than five eighths (⅝), more particularly more than seven eighths (⅞) of the number (L) of chips of the first pattern (p₀).
EXAMPLE 6. The method of any one of EXAMPLEs 1 to 5,
wherein the predefined duration (T_{c}) is longer than 10 ns, in particular longer than 30 ns, in particular longer than 100 ns, in particular longer than 300 ns, in particular longer than 1000 ns.
EXAMPLE 7. The method of any one of EXAMPLEs 1 to 6,
wherein the predefined duration (T_{c}) is longer than a delay spread of a channel according to the standardized Extended Pedestrian A (EPA) channel model.
EXAMPLE 8. The method of any one of EXAMPLEs 1 to 7,
wherein the predefined duration (T_{c}) is shorter than 200 ms, in particular shorter than 180 ms, in particular shorter than 60 ms, in particular shorter than 24 ms, in particular shorter than 13 ms, in particular shorter than 9 ms, in particular shorter than 6 ms, in particular shorter than 5 ms.
EXAMPLE 9. The method of any one of EXAMPLEs 1 to 8,
wherein the predefined duration (T_{c}) is shorter than a coherence time of a channel according to the standardized Extended Pedestrian A (EPA) channel model.
EXAMPLE 10. The method of any one of EXAMPLEs 1 to 9,
wherein the number of chips of the first pattern (p₀) is greater than 400, in particular greater than 1000, in particular greater than 1300, in particular greater than 2000.
EXAMPLE 11. A method of receiving a data bit transmitted by a wireless device by passing, in particular reflecting or forwarding, or absorbing an incoming signal, in particular an incoming ambient signal, by a receiver device, the method comprising
   obtaining (1001) a third pattern (q) comprising a number (L) of chips having a predefined duration (T_{c}),
wherein a chip of the third pattern (q) is zero if corresponding chips of a first pattern (p₀) associated with a data bit value zero (0) and a second pattern (p₁) associated with a data bit value one (1) are equal,
wherein a chip of the third pattern (q) has a positive sign if a corresponding chip of the first pattern (p₀) is greater than a corresponding chip of the second pattern (p₁),
wherein a chip of the third pattern (q) has a negative sign if a corresponding chip of the first pattern (p₀) is smaller than a corresponding chip of the second pattern (p₁),
   decoding (1002) a received pattern (r) representing the data bit based on the third pattern (q).
EXAMPLE 12. The method of EXAMPLE 11,
wherein decoding (1002) the received pattern (r) based on the third pattern (q) comprises multiplying the third pattern (q) with the received pattern (r) to obtain a fourth pattern (y),
EXAMPLE 13. The method of EXAMPLE 12,
wherein decoding (1002) the received pattern (r) comprises
summing up the chips of the fourth pattern (y) to obtain a sum.
EXAMPLE 14. The method of EXAMPLE 13,
wherein decoding (1002) the received pattern (r) comprises deriving whether the sum is greater or smaller than zero to obtain a data bit value of a received data bit (d).
EXAMPLE 15. The method of any one of EXAMPLEs 11 to 14,
wherein obtaining (1001) the third pattern (q) comprises
obtaining the first pattern (p₀),
obtaining the second pattern (p₁), and
deriving the third pattern (q) from the first pattern (p₀) and the second pattern (p₁).
EXAMPLE 16. The method of any one of EXAMPLEs 11 to 15,
wherein the method comprises receiving a further data bit transmitted by a further wireless device by passing, in particular reflecting or forwarding, or absorbing an incoming signal, in particular an ambient signal, by the receiver device, the method comprising
   obtaining a further third pattern (q₂) comprising the number (L) of chips having the predefined duration (T_{c}),
wherein a chip of the further third pattern (q₂) is zero if corresponding chips of a further first pattern (p_{2,0}) associated with a further data bit value zero (0) and a further second pattern (p_{2,1}) associated with a further data bit value one (1) are equal,
wherein a chip of the further third pattern (q₂) has a positive sign if a corresponding chip of the further first pattern (p_{2,0}) is greater than a corresponding chip of the second pattern (p_{2,1}), wherein a chip of the further third pattern (q₂) has a negative sign if a corresponding chip of the further first pattern (p_{2,0}) is smaller than a corresponding chip of the further second pattern (p_{2,1}),
   decoding the received pattern (r) representing the data bit based on the further third pattern (q₂),
wherein a peak to off-peak cross-correlation of the further first pattern (p_{2,0}) and/or further second pattern (p_{2,1}) with the first pattern (p₀) and/or second pattern (p₁) is at least

$$\sqrt[2]{L / 2} .$$

EXAMPLE 17. A wireless device (120) comprising control circuity, wherein the control circuitry is configured for performing the method according to any one of EXAMPLEs 1 to 10.
EXAMPLE 18. A receiver device (130) comprising control circuitry, wherein the control circuitry is configured for performing a method according to any one of EXAMPLES 11 to 15.

1. A method of transmitting a data bit by passing or absorbing, by a wireless device, an incoming signal, the method comprising:
for a data bit value zero, obtaining a first pattern comprising a number of chips having a predefined duration,
for a data bit value one, obtaining a second pattern comprising the number of chips having the predefined duration, and
either passing or absorbing, during each chip, the incoming signal in accordance with the first pattern or the second pattern, wherein the first pattern and the second pattern are selected to have an equal number of chips during which the incoming signal is absorbed.

2. The method of claim 1, wherein the first pattern and the second pattern are different.

3. The method of claim 1, wherein the number of chips during which the incoming signal is absorbed is less than six eighths, in particular less than five eighths, more particularly less than four eighths of the number of chips of the first pattern.

4. The method of claim 1, wherein the number of chips during which the incoming signal is absorbed is more than two eights, in particular more than three eighths, more particularly more than four eighths of the number of chips of the first pattern.

5. The method of claim 1, wherein a number of chips where the first pattern and the second pattern differ is more than three eighths, in particular more than five eighths, more particularly more than seven eighths of the number of chips of the first pattern.

6. The method of claim 1, wherein the predefined duration is longer than 10 ns, in particular longer than 30 ns, in particular longer than 100 ns, in particular longer than 300 ns, in particular longer than 1000 ns.

7. The method of claim 1, wherein the predefined duration is longer than a delay spread of a channel according to the standardized Extended Pedestrian A channel model.

8. The method of claim 1, wherein the predefined duration is shorter than 200 ms, in particular shorter than 180 ms, in particular shorter than 60 ms, in particular shorter than 24 ms, in particular shorter than 13 ms, in particular shorter than 9 ms, in particular shorter than 6 ms, in particular shorter than 5 ms.

9. The method of claim 1, wherein the predefined duration is shorter than a coherence time of a channel according to the standardized Extended Pedestrian A channel model.

10. The method of claim 1, wherein the number of chips of the first pattern is greater than 400, in particular greater than 1000, in particular greater than 1300, in particular greater than 2000.

11. A method of receiving a data bit transmitted by a wireless device by passing or absorbing an incoming signal, by a receiver device, the method comprising
obtaining a third pattern comprising a number of chips having a predefined duration,
wherein a chip of the third pattern is zero if corresponding chips of a first pattern associated with a data bit value zero and a second pattern associated with a data bit value one are equal,
wherein a chip of the third pattern has a positive sign if a corresponding chip of the first pattern is greater than a corresponding chip of the second pattern,
wherein a chip of the third pattern has a negative sign if a corresponding chip of the first pattern is smaller than a corresponding chip of the second pattern,
decoding a received pattern representing the data bit based on the third pattern.

12. The method of claim 11, wherein decoding the received pattern based on the third pattern comprises multiplying the third pattern with the received pattern to obtain a fourth pattern.

13. The method of claim 12, wherein decoding the received pattern comprises summing up the chips of the fourth pattern to obtain a sum.

14. The method of claim 13, wherein decoding the received pattern comprises deriving whether the sum is greater or smaller than zero to obtain a data bit value of a received data bit.

15. The method of claim 11,
wherein obtaining the third pattern comprises
obtaining the first pattern,
obtaining the second pattern, and
deriving the third pattern from the first pattern and the second pattern.

16. The method of claim 11,
wherein the method comprises receiving a further data bit transmitted by a further wireless device by passing or absorbing an incoming signal, by the receiver device, the method comprising
obtaining a further third pattern comprising the number of chips having the predefined duration,
wherein a chip of the further third pattern is zero if corresponding chips of a further first pattern associated with a further data bit value zero and a further second pattern associated with a further data bit value one are equal,
wherein a chip of the further third pattern has a positive sign if a corresponding chip of the further first pattern is greater than a corresponding chip of the second pattern,
wherein a chip of the further third pattern has a negative sign if a corresponding chip of the further first pattern is smaller than a corresponding chip of the further second pattern,
decoding the received pattern representing the data bit based on the further third pattern,
wherein a peak to off-peak cross-correlation of the further first pattern and/or further second pattern with the first pattern and/or second pattern is at least
$$\sqrt[2]{L / 2} .$$

17. A wireless device comprising control circuity, wherein the control circuitry is configured for performing the method according to claim 1.

18. A receiver device comprising control circuitry, wherein the control circuitry is configured for performing the method according to claim 11.
